(19) United States
(12) Patent Application Publication
(10) Pub. No.: US 2016/0011591 A1
(43) Pub. Date: Jan. 14, 2016

(54) METHOD FOR MONITORING AN EVENT-CONTROLLED FUNCTION AND MONITORING APPARATUS FOR CARRYING OUT AN EVENT-CONTROLLED FUNCTION

(71) Applicant: SIEMENS AKTIENGESELLSCHAFT, München (DE)

(72) Inventors: Stefan RUNDE, Walzbachtal (DE); Bernhard SCHENK, Feucht (DE); Andreas SCHOLZ, Unterschleissheim (DE)

(73) Assignee: SIEMENS AKTIENGESELLSCHAFT, München (DE)

(21) Appl. No.: 14/770,787

(22) PCT Filed: Feb. 11, 2014
(86) PCT No.: PCT/EP2014/052576

§ 371 Date: Aug. 26, 2015

(30) Foreign Application Priority Data
Feb. 28, 2013 (DE) 10 2013 203 435.0

(51) Int. Cl. G05B 23/02

(52) U.S. Cl. CPC G05B 23/0224

(57) ABSTRACT

The resource consumption of automation systems having a service-oriented architecture is monitored by determining individual parameters for the resource requirement and the processing performance for individual subfunctions, respectively, within the service-oriented architecture. Critical subfunctions can therefore be reliably identified and adapted, if necessary, by individually analyzing the processing parameters for individual subfunctions during event-controlled processing.

### CROSS REFERENCE TO RELATED APPLICATIONS

This application is the U.S. national stage of International Application No. PCT/EP2014/052576, filed Feb. 11, 2014 and claims the benefit thereof. The International Application claims the benefit of German Application No. 10 2013 203 435.0 filed on Feb. 28, 2013, both applications are incorporated by reference herein in their entirety.

### BACKGROUND

Described below is a method for monitoring an event-controlled function in a system having a service-oriented architecture, and to a monitoring apparatus for executing an event-controlled function.

Service-oriented architectures (SOA) are known from the field of company software. They are used here to structure large and complex IT systems. The principles of service-oriented architectures can likewise be applied to automation technology. In this case, complex automation functions can be broken down into completed subfunctions. For example, a typical control loop, in which an actuator is controlled on the basis of the signals from one or more sensors, can be subdivided into a plurality of subfunctions.

In this case, a first subfunction may be data acquisition in a sensor, for example. The raw data from the sensor can then be converted and calibrated in a further subfunction if necessary. In another subfunction, it is possible to smooth or interpolate the preprocessed sensor data, for example. It is then possible to determine, in a further subfunction, how the system is intended to be adjusted on the basis of the data preprocessed in this manner. Finally, an actuator is controlled on the basis of the previously determined control parameters as a further subfunction. In contrast to known systems in which the individual subfunctions are connected to one another via a common data memory, the individual subfunctions are explicitly combined in a service-oriented architecture by stipulating communication connections between the individual subfunctions. It is therefore possible to execute the individual subfunctions on the corresponding devices in an event-controlled manner as soon as the previous subfunction provides new data. For example, WO 2008/135459 A discloses a collaborative automation system based on a service-oriented architecture.

In contrast to executing subfunctions in an event-controlled manner in service-oriented architectures, individual substeps are usually carried out in a cyclical manner in previously used systems. In this case, the known methods for monitoring the resource consumption, for example the CPU utilization, memory consumption, network utilization or the like, are not very meaningful for executing subfunctions in an event-controlled manner in a service-oriented architecture. Even if the average execution time for the sum of all substeps within a cycle is below the required time, it cannot be concluded from this that problematic delays in the execution of individual subfunctions have not nevertheless occurred on account of peak loads. In addition, individual subfunctions may have different requirements with respect to their propagation time behavior. For example, different requirements for the response time of a control loop may be imposed depending on the inertia of a monitoring process. These result in different requirements with respect to the maximum response time of a subfunction. An average utilization or the indication of an average execution time, as is considered during cyclical execution, is therefore not very meaningful for complying with the requirements of a subfunction in a service-oriented architecture.

There is therefore a need for a method and an apparatus for monitoring event-controlled functions in a system having a service-oriented architecture.

### SUMMARY

According to one aspect, a method for monitoring an event-controlled function in a system having a service-oriented architecture includes detecting a request for an event-controlled function; executing the event-controlled function; and determining processing parameters of the event-controlled function.

According to another aspect, a monitoring apparatus for a processing apparatus for executing an event-controlled function includes a detector device which is designed to detect the arrival of an event for an event-controlled function; an execution apparatus which is designed to initiate execution of the event-controlled function in the processing apparatus on the basis of the detected event; and an apparatus for determining processing parameters, which is designed to determine processing parameters during execution of the event-controlled function.

An embodiment individually monitors the individual event-controlled functions in a system having a service-oriented architecture and in the process to determine the processing parameters for characterizing the sequence of the function. It is therefore possible to individually determine the resource consumption for each individual subfunction of the service-oriented architecture.

One advantage of individually determining processing parameters for each individual subfunction is that a deviation from the requirements of the respective subfunction can be detected particularly quickly and reliably.

For example, if the execution time of a subfunction exceeds a predefined maximum value, this can be immediately detected and countermeasures can then be initiated if necessary.

Another advantage is that each individual subfunction can be individually considered and can be compared with a separate requirement. A possibly problematic subfunction can therefore be quickly identified.

It is also advantageous that requirements can be individually formulated for each subfunction. Each subfunction can therefore be individually assessed on the basis of relevant parameters and adapted if necessary.

According to one embodiment of the method for monitoring an event-controlled function, the determined processing parameters include a period for executing the event-controlled function, a resource requirement for executing the event-controlled function and/or communication parameters. Determining the period for execution makes it possible to reliably detect when the processing period is exceeded. Assessing the resource requirement over each individual subfunction makes it possible to quickly adapt the resources provided, for example storage space for a subfunction, if necessary. Analyzing the communication parameters, for example a data throughput or the like, makes it possible to individually detect, analyze and possibly eliminate weak points when interchanging data or the like for each individual subfunction.

According to another embodiment, the method includes comparing the determined processing parameters with predetermined requirement parameters. Predefining predetermined requirement parameters makes it possible to easily define threshold values which should not be exceeded by the individual subfunctions of the system having a service-oriented architecture. Critical functions can therefore be easily identified by comparing the actually determined processing parameters with the predetermined requirement parameters and suitable countermeasures can then be initiated.

According to another embodiment, the method includes classifying the determined processing parameters. Classifying the processing parameters, for example by comparing the processing parameters with predetermined requirement parameters or else other alternative classification methods, makes it possible to analyze the operating state in the system having the service-oriented architecture in a particularly simple manner. Critical states can be analyzed and detected in a particularly simple manner on the basis of the classification.

In another embodiment, the method includes storing the determined processing parameters. Storing the determined processing parameters means that these processing parameters are also available for subsequent evaluation and analysis of the system.

In another embodiment, the method includes selecting resources, the resources being selected on the basis of the determined processing parameters. Selecting resources for the execution of individual event-controlled functions on the basis of determined processing parameters makes it possible to deliberately control the system, with the result that all event-controlled functions can run within predefined specifications.

According to another embodiment, the method includes visualizing the determined processing parameters. As a result of the determined processing parameters being visualized, the operating state of the system can be indicated to a user in a particularly simple and reliable manner and critical states which occur can be quickly detected and eliminated if necessary.

In another embodiment, the method includes transmitting the determined processing parameters. Transmitting the previously determined processing parameters makes it possible for these parameters to also be received and evaluated at a remote location, with the result that the system can also be monitored from a remote location. If necessary, countermeasures can therefore be initiated when a critical state occurs even if a user is not directly on site.

In another embodiment, the monitoring apparatus also includes a storage apparatus which is designed to store the determined processing parameters.

According to another embodiment, the monitoring apparatus includes a display device which is designed to display the determined processing parameters.

According to yet another embodiment, the monitoring apparatus includes a communication interface which is designed to transmit the determined processing parameters.

Also described below is an automation system having a service-oriented architecture for executing an event-controlled function in a processing apparatus, with a monitoring apparatus as described.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic block diagram of an automation system having a service-oriented architecture;

FIG. 2 is a schematic block diagram of part of a service-oriented architecture having a monitoring apparatus according to one embodiment; and

FIG. 3 is a flowchart of a method for monitoring an event-controlled function in a system having a service-oriented architecture, on which one exemplary embodiment is based.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The drawings illustrated in the figures are partially perspective illustrations of elements which are not necessarily depicted true to scale for reasons of clarity. The same reference symbols denote generally identical or identically acting components.

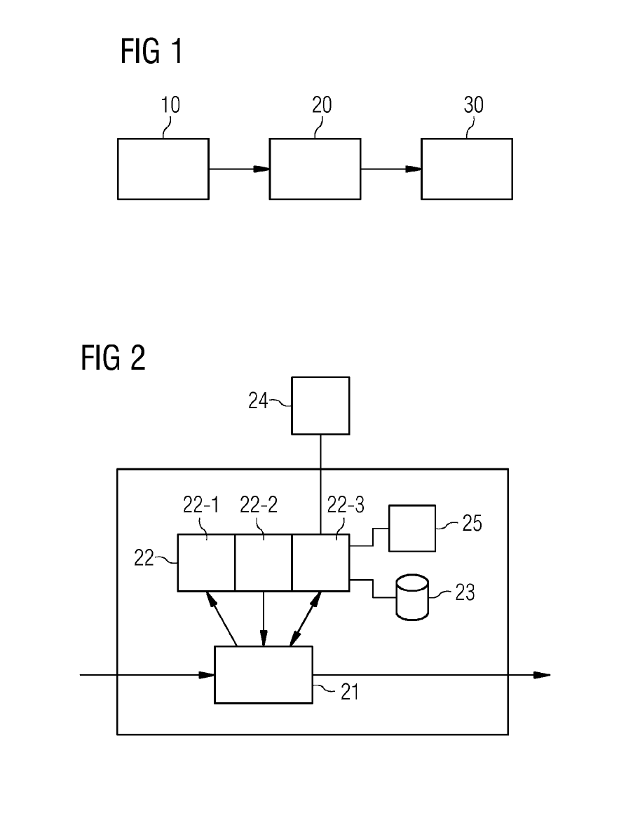

FIG. 1 shows the schematic illustration of an automation system based on a service-oriented architecture. For example, such an automation system can be used to implement a control loop. In this case, one or more sensors 10 record any desired measured values, for example. Such measured values may be, for example, environmental influences or parameters of a machine (pressure, speed, current, voltage, etc.).

In the simplest case, the sensor 10 provides raw data relating to the recorded measured values or else values which have already been preprocessed and have been calculated on the basis of the sensor data. After the sensor 10 has output appropriate data, these sensor data are transmitted to a further entity, for example a processing apparatus 20.

Depending on the complexity, a plurality of entities may also be connected in succession instead of an individual processing apparatus 20. In the case of a control loop, the values output by the sensors 10 may be converted and/or calibrated if necessary, for example. The measured values can then possibly be preprocessed further; for example, one or more processes in which the values are smoothed and/or interpolated may follow. The measured values possibly preprocessed in this manner can then be analyzed in a further subfunction and decisions can then be determined for a necessary control behavior. The output of this control behavior determined in this manner can then be transmitted to an actuator 30. This actuator 30 adapts the manipulated variables in the process on the basis of the received values, for example.

As is clear from the example described above, the subfunctions within the control loop are each based on the output values from an upstream subfunction. In a service-oriented architecture, a function should therefore be executed as promptly as possible when there is a corresponding need. Specifically, such a need to execute an event-controlled function is usually signaled by virtue of an upstream entity transmitting its output to the subsequent entity.

FIG. 2 shows a schematic illustration of a processing apparatus for executing an event-controlled function according to one embodiment. In this case, the processing apparatus 21 receives a request to execute a function from an upstream entity. For example, this request may be made by transmitting any desired data to an input memory (not illustrated) of the processing apparatus 21. According to the example described above, sensors 10 may transmit their sensor data to the processing apparatus 21, for example. In its detector device 22-1, the monitoring apparatus 22 detects the request to execute an event-controlled function. For example, this may be the reception of data from the upstream entity. However, if the upstream entity does not provide any explicit data in the form of measured values or the like, for example, an event-controlled function can also likewise be initiated by transmitting an initialization signal.

After the detector device 22-1 has detected the arrival of an event for an event-controlled function, the execution device 22-2 initiates execution of the event-controlled function in the processing apparatus 21 on the basis of the detected event. If the processing apparatus 21 is already dealing with the execution of another function upon the arrival of the data which initiate a further event-controlled function, the execution of the new event-controlled function can also be postponed for the time being. If the execution device 22-2 detects at a subsequent time that the processing apparatus 21 has finished its previous processes, the execution device 22-2 can then cause the processing device 21 to execute the new function.

For this purpose, the processing apparatus 21 will read the possibly received data from its input memory and will process the data. For this purpose, a suitable computer program code may possibly be read from a program memory (not illustrated) and processing in the processing apparatus 21 may be carried out on the basis of this program code.

During execution of the event-controlled function in the processing apparatus, the processing is monitored by the apparatus 22-3 for determining processing parameters. In this case, this apparatus 22-3 for determining processing parameters determines those parameters which characterize the execution of the function currently being processed. For example, the period for executing the event-controlled function which is currently running in the processing apparatus can be determined here. For this purpose, the apparatus 22-3 must determine the period between the initialization of the processing apparatus 21 and the time at which the corresponding event-controlled function has been completely concluded.

Additionally or else alternatively, the apparatus 22-3 for determining processing parameters may also determine the required resource requirement, for example the storage requirement, during processing of the corresponding function. Furthermore, it is also possible to assess the required network resources for determining processing parameters, in particular if communication with further subassemblies is required. In addition, it is likewise possible to determine further processing parameters during execution of an event-controlled function in the processing unit 21.

The processing parameters obtained in this manner during execution of a function in the processing unit 21 are then available for assessment and analysis. For example, the period needed to execute a function may be assessed. It is therefore immediately possible, in particular in the case of time-critical functions, to detect when the maximum permissible processing time is exceeded. An individual assessment and analysis can be carried out for each individual subfunction on the basis of the determined processing parameters. Alternative assessment possibilities are also likewise possible. For example, the compliance with particular criteria over a sequence of functions running in succession can also be used as a benchmark. The tolerance of the determined processing parameters for a sequence of identical event-controlled functions may also possibly be a suitable measure for the assessment. For example, it is possible to detect when the resource consumption determined by the processing parameters deviates from the resource consumption of previous functions and an unusual deviation, for example, can be inferred on the basis thereof.

In particular, suitable requirement parameters which have to be complied with during execution of a function can also be defined for each function, for example. If it is then determined on the basis of the determined processing parameters that the predefined requirement parameters could not be complied with during execution, the corresponding subfunction which does not comply with the predefined requirement parameters can then be immediately identified.

For example, such predetermined requirement parameters may be a maximum period for executing a function or else a maximum permissible resource requirement, for example a maximum storage space requirement, but also a maximum bandwidth for data transmission or the like. Further, additional or alternative requirement parameters are likewise possible.

Furthermore, a corresponding classification of the event-controlled functions is possible on the basis of the determined processing parameters and possibly also on the basis of the predefined requirement parameters. For example, in a simple case, a distinction can be made between functions which comply with the predefined requirement parameters and those for which the predefined processing parameters are not complied with. However, a further classification into still acceptable deviations and particularly critical deviations from predefined requirement parameters is possibly also possible.

The processing parameters determined in this manner and possibly also the analysis based on the predefined requirement parameters and possibly the classification can then also be stored in a storage device 23. For example, the determined processing parameters, for example the period for execution or the like, can be stored for each event-controlled function which has been executed in tabular form. Alternative types of storage, for example in separate storage areas for separate data relating to event-controlled functions or in separate storage areas for different types of processing parameters, are likewise possible.

Furthermore, it is also possible to transmit the determined processing parameters via a communication interface 25. For example, the determined processing parameters can be transmitted, immediately after their determination, to a remote location for further processing via the communication interface 25. Additionally or alternatively, it is also likewise possible to likewise transmit processing parameters from the storage device 23 which have already been previously stored to a remote location via the communication interface 25.

Furthermore, the determined processing parameters may also be displayed on a display device 24. Such a display device 24 may be directly connected to the monitoring apparatus 22, for example, and can therefore display the processing parameters directly in situ on the processing apparatus. For example, this display device 24 may be a display, for example a monitor, a TFT screen or any other desired type of display device. In this case, the display device 24 may furthermore also include or be connected to a suitable data processing system which previously preprocesses the processing parameters and presents them on the display device 24 in a presentation form suitable for a user. The system state can therefore be presented to a user on a suitable user interface in a manner which is particularly clear and simple to comprehend. In the case of critical operating states, the user can therefore quickly detect these states and can initiate suitable countermeasures. In this case, it is possible to adapt the representation in terms of color when displaying determined processing parameters. Unusual deviations and critical operating states can therefore be perceived by a user in a particularly rapid manner. Furthermore, depending on the system state and assessment of the determined processing parameters, acoustic signaling is also conceivable in order to quickly draw the user's attention to particular system states.

As an alternative to manual intervention by a user, the system can also be automatically adapted when critical operating states occur based on the determined processing parameters. For example, the available resources can be adapted for the execution of further event-controlled functions on the basis of the determined processing parameters. It is possible, for example, to provide a larger part of the main memory, to adapt the capacities for transmitting data from or to further entities, possibly to give different priorities to different functions or possibly also to adapt the clock rate of a microprocessor system. Further operations for adapting the resources based on the determined processing parameters are also likewise possible.

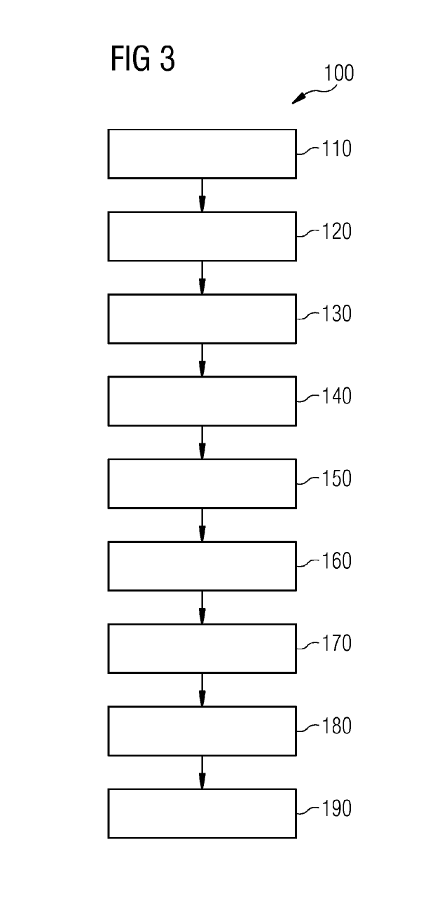

FIG. 3 shows the schematic illustration of a method 100 for monitoring an event-controlled function in a system having a service-oriented architecture, on which one embodiment is based. A request for an event-controlled function is first of all detected in 110. A request can be detected, for example, by virtue of an upstream entity either storing input data in the input memory of a processing unit 21 and/or transmitting a request signal to the processing unit 21. If the processing unit 21 is then ready to execute the requested function, the corresponding function is started in 120. In contrast, if the corresponding processing unit 21 is still dealing with other functions, the execution of the requested function is postponed for the time being. In an alternative embodiment, if a particularly critical function or a function with a high priority is requested, the function currently being executed can also be interrupted and the prioritized function can then be immediately started. Further possibilities for prioritizing functions are also likewise possible.

During execution of the requested event-controlled function in the processing unit 21, one or more processing parameters which characterize the execution of the event-controlled function are determined in 130. These processing parameters may be, for example, the period for execution, the necessary resource requirement or the bandwidth for required data communication.

In order to assess the determined processing parameters of the event-controlled function, the determined processing parameters can also be compared with predetermined requirement parameters in 140. These predetermined requirement parameters may be, for example, values which have already been previously permanently stored in a memory (not illustrated). Alternatively, these predetermined requirement parameters may also be individually provided for the functions to be executed in each case.

In order to easily and reliably assess the determined processing parameters, the determined processing parameters may also be classified in 150. For this purpose, a simple classification can be carried out, for example, by virtue of the predefined requirement parameters being undershot or exceeded. A further classification 160 into a plurality of subgroups, for example “okay”, “slightly critical”, “no longer permissible” or the like, is likewise possible.

On the basis of the determined processing parameters described above, the selection of resources, for example communication bandwidth, available memory, prioritization of individual functions, processor clock rate or the like, can also be adapted in 170 in order to possibly carry out an optimization if requirement parameters are not complied with. In particular, this adaptation of the resources can be carried out iteratively, for example.

In order to quickly and easily acquire the determined processing parameters, these processing parameters may be visualized in 180. For example, the processing parameters may be directly presented on the processing apparatus or else on a display unit 24 at a remote location for this purpose. Previous processing of the available processing parameters and preprocessing make it possible to conveniently present the determined processing parameters in a suitable user interface, for example. Technical states during the processing of individual functions can therefore be quickly detected by the user, in particular during the development of new systems but also during normal operation, and suitable countermeasures can then be initiated if necessary.

If the processing parameters are not, or at least not exclusively, intended to be directly evaluated in the processing unit 21, the determined processing parameters can also be transmitted to a remote location in 190. This transmission can be effected, for example, using a known network interface and a wired network. Alternatively, wireless transmissions such as WLAN, Bluetooth, mobile radio or the like are likewise possible. Remote users can therefore also be promptly informed of critical states.

In addition to the exclusive determination of processing parameters for each individual function separately, processing parameters for a plurality of functions can also be combined and can continue to be provided as a common processing parameter. For example, the individual processing periods of a plurality of subfunctions can be combined and, if useful, this combined period can be provided as a common processing parameter for a plurality of processing operations. The volumes of data which arise can therefore possibly be reduced. Furthermore, data combined in this manner can also be understood and analyzed by a user in a simpler manner without the user being overwhelmed with unnecessarily large volumes of data.

In summary, by novel monitoring of the resource consumption of automation systems having a service-oriented architecture, parameters for the resource requirement and for the processing performance are each individually determined for individual subfunctions within the service-oriented architecture. The individual analysis of the processing parameters for individual subfunctions during event-controlled processing therefore makes it possible to reliably identify and possibly adapt critical subfunctions.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method for monitoring an event-controlled function in a system having a service-oriented architecture, comprising:
detecting a request for an event-controlled function;
executing the event-controlled function; and
determining processing parameters of the event-controlled function.

15. The method as claimed in claim 14, wherein the processing parameters include at least one of a period for executing the event-controlled function, a resource requirement for executing the event-controlled function and communication parameters.

16. The method as claimed in claim 14, further comprising comparing the processing parameters with predetermined requirement parameters.

17. The method as claimed in claim 14, further comprising classifying the processing parameters.

18. The method as claimed in claim 14, further comprising storing the processing parameters.

19. The method as claimed in claim 14, further comprising selecting resources based on the processing parameters.

20. The method as claimed in claim 14, further comprising displaying the processing parameters.

21. The method as claimed in claim 14, further comprising transmitting the processing parameters.

22. A monitoring apparatus monitoring a processing apparatus for execution of an event-controlled function, comprising:
a detector device configured to detect arrival of an event associated with an event-controlled function;
an execution device configured to initiate execution of the event-controlled function in the processing apparatus upon detection of the event; and
an apparatus configured to determine processing parameters during execution of the event-controlled function.

23. The monitoring apparatus as claimed in claim 22, further comprising a storage device configured to store the processing parameters determined by the apparatus.

24. The monitoring apparatus as claimed in claim 22, further comprising a display configured to display the processing parameters.

25. The monitoring apparatus as claimed in claim 22, further comprising a communication interface configured to transmit the processing parameters.

26. An automation system having a service-oriented architecture for executing an event-controlled function in a processing apparatus, comprising:
a monitoring apparatus monitoring the processing apparatus for execution of the event-controlled function, including:
a detector device configured to detect arrival of an event associated with an event-controlled function;
an execution device configured to initiate execution of the event-controlled function in the processing apparatus upon detection of the event; and
an apparatus configured to determine processing parameters during execution of the event-controlled function.

27. The automation system as claimed in claim 26, wherein said monitoring apparatus further includes a storage device configured to store the processing parameters determined by the apparatus.

29. The automation system as claimed in claim 26, wherein said monitoring apparatus further includes a display configured to display the processing parameters.

29. The automation system as claimed in claim 26, wherein said monitoring apparatus further includes a communication interface configured to transmit the processing parameters.
